(19) United States
(12) Patent Application Publication
(10) Pub. No.: US 2007/0011078 A1
(43) Pub. Date: Jan. 11, 2007

(54) Click-fraud reducing auction via dual pricing

(75) Inventors: Kamal Jain, Bellevue, WA (US); Kunal Talwar, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/178,528

(22) Filed: Jul. 11, 2005

(51) Int. Cl. G06Q 40/00

(52) U.S. Cl. 705/37

(57) ABSTRACT

In auctioning advertising opportunities presented over a network, dual pricing reduces effects of fraudulent behavior causing showing or selection of a bidder's ads. In addition to a per selection bid or per showing bid presented by a bidder, a constructive bid opposite that offered by the bidder is derived from the bid offered and a rate of expected selections per showing. The costs resulting from the number of times the ad is both shown and selected are monitored. The price paid by the bidder is determined by the lower of the two costs. Behavior by another party causing the ad to be fraudulently shown or selected will not affect the bidder unless the party causes both a high number of showings and a high number of selections. Setting a price over a plurality of auction periods reduces the effect of fraudulent behavior perpetrated by the bidder regarding its own ads.

### BACKGROUND

Internet search engines, web-based e-mail, on-line reference sources, television programming guides, and providers of similar services earn revenue by presenting selectable advertisements over networks. The ads may be directed to any person likely to use the service, or the ads may be targeted to those whose actions indicate interest in a particular type of good or service.

For example, FIG. 1A shows a search engine web page 100 that allows a person to perform a web search. To perform the search, the person enters search terms in search field 102. The person then selects or “clicks” on a search button 104 by directing a pointing device (not shown) to position a cursor 108 over search button 104 and pressing a button on the pointing device. In this example, the user performs a search 106 consisting of the term “Camera.”

As shown in FIG. 1B, and familiar to most Internet users, the search engine returns a results screen 150 listing links 152 to web pages relevant to search 106. Links 152 are presented and ranked according to their relevance to search 106 (FIG. 1A). In addition to links 152, results screen 150 also includes ads 154, 156 and 158. Banner ad 154, displayed prominently across the top of results page 150, bears an ad for “BOB'S CAMERA.” Banner ad 156, displayed aside of results screen 150, presents a banner ad for “DISCOUNT CAMERAS.” On another side of results screen 150, a list of sponsored links 158 is presented. Sponsored links 158 are links are responsive to the user's search, but are not necessarily as relevant as links 152. Sponsored links 158, like ads 154 and 156, appear because advertisers have paid for them to be presented. Pop-up windows (not shown), which present another window over results screen 150, also may be used to present ads.

If the user wants to learn more about or purchase what is described by ads 154, 156, and 158, the user positions cursor 160 over the ad and selects it. The likelihood of the user selecting an ad increases if the ad concerns a good or service of interest to the user. Thus, it is not a coincidence that the user's search 106 (FIG. 1A) on the term “camera” resulted in ads 154 and 156 for camera vendors being presented on results page 150. Advertisers arrange with service providers for their ads to be presented when a user shows an interest in the advertiser's business, such as by performing a searching including a term that describes the advertiser's business.

Typically, advertisers agree to pay the search engine provider either each time one of the advertiser's ads either is presented, or each time one of the advertiser's ads is selected or “clicked” by a user. Presumably, ads are selected by users who wish to purchase or learn more about the advertiser's goods or services. Because an ad may be shown dozens or hundreds of times before a user clicks the ad, advertisers who wish to pay per selection or “per click” will pay a higher unit price than advertisers who choose to pay “per showing” or “per impression.”

Unfortunately, there is a possibility of unscrupulous behavior by competitors. For example, competitors, such as “BOB'S CAMERA” and “DISCOUNT CAMERA,” whose ads 154 and 156, respectively, both bid for advertising opportunities with the same web-based service provider. BOB'S CAMERA may be a smaller firm with less advertising resources than DISCOUNT CAMERA. To make the most of its resources, BOB'S CAMERA may bid for advertising opportunities on a per selection basis, hoping to spend its limited resources on consumers who show interest in its business by clicking on its ads.

For example, for a day or another predetermined advertising period, BOB'S CAMERA may bid $1 per click for advertising opportunities, specifying a limit or budget of $50. By contrast, advertising opportunities sold on a per impression basis may be available for 1.0¢. However, despite the much lower per showing price, BOB'S CAMERA may prefer to spend $1 per selection, thereby spending the $1 on a user who shows interest in its products, rather than spend that same $1 for 100 impressions of its ad, none of which may ever be selected.

Unfortunately, if DISCOUNT CAMERA knows or believes that BOB'S CAMERA has bid for advertising opportunities on a per selection basis, DISCOUNT CAMERA may try to undermine BOB'S CAMERA's advertising efforts. An agent of DISCOUNT CAMERA may repeatedly perform the “camera” search 106 (FIG. 1A), resulting in ad 154 (FIG. 1B) for BOB'S CAMERA appearing on results screen 150. The agent then selects ad 154, exhausting part of BOB'S CAMERA's auction budget. The agent of DISCOUNT CAMERA could repeatedly search 106 and select ad 154 and, in a matter of minutes, exhaust the budget of its competitor.

If BOB'S CAMERA bid on a per showing basis, DISCOUNT CAMERA similarly could undermine its competitor's advertising efforts. It would take far more showings of the ad at 1.0¢ per showing to exhaust the $50 budget of BOB'S CAMERA. Nonetheless, the agent could exhaust or at least diminish the auction budget of its competitor by repeatedly performing searches to cause BOB'S CAMERA's ads to be shown, without taking the time to select the ads.

Unfortunately, if DISCOUNT CAMERA is successful in undermining its competitor's advertising, BOB'S CAMERA will be less likely to gain customers through its Internet advertising campaign. Thus, BOB'S CAMERA subsequently may bid less or not bid at all for future advertising opportunities. As a result, demand for advertising opportunities is reduced, and DISCOUNT CAMERA will be able to acquire advertising opportunities for a lower price than if it had to continue to bid against BOB'S CAMERA.

The reduced competition for advertising opportunities also harms the service provider who will not earn as much advertising revenue. The reduced competition harms consumers who may otherwise never learn of another possible vendor. BOB'S CAMERA potentially is harmed most of all, having paid for advertising opportunities that were never seen or clicked on by actual consumers.

Processes exist that attempt to protect advertisers against such unscrupulous behavior. For example, machine learning systems have been proposed to identify potential selection fraud arising from attempts to exhaust the budget of a competitor. By monitoring the rapidity or regularity with which the ads are selected or clicked, these machine learning systems differentiate selections made by interested users from instances of selection fraud or “click fraud.”

These systems, however, tend to require large amounts of input data to be effective. Unfortunately, an advertiser with a modest advertising budget choosing to bid on a per selection basis might have its advertising budget depleted by a competitor without enough data being generated for machine learning systems to identify the fraudulent behavior.

### SUMMARY

Dual pricing is used to reduce effects of fraudulent behavior in an auction for advertising opportunities. For one example, a bidder may offer a per selection bid. Using the per selection bid and an expected rate of a number of times an ad will be selected per number of showings, a constructive per showing bid is determined. The number of selections and the number of showings of the bidder's ad are both tracked. A selection cost is computed using the per selection bid and the number of selections. A showing cost is computed using the constructive per showing bid and the number of showings.

In one embodiment, an auction budget presented by the bidder is considered depleted only when both the selection cost and the showing cost reach the auction limit. In another embodiment, if the limit is not reached, the bidder is charged the lesser of the selection cost and the showing cost. Thus, for example, even if an unscrupulous competitor were to select enough of the bidder's ads to deplete the bidder's auction budget, the ad would continue to be shown until the showing cost also reached the auction budget. Thus, the bidder's auction budget is protected from the competitor's behavior, and competitors should be deterred from future attempts to undermine the bidder's advertising efforts.

Protection against fraud may motivate a bidder to select its own ads to manipulate its advertising positions. However, by revising the rate of number of selections per number of showings expected and/or charging a bidder for a plurality of auction periods, the bidder also should be deterred from fraudulent behavior.

Embodiments of dual pricing may present large bodies of selection and showing data for training of fraud detection systems that are usable with dual pricing.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIGS. 1A and 1B (Prior Art) are screens illustrating results of a search presenting a number of ads.

FIG. 2 is a flow diagram illustrating the logical steps of a mode of dual pricing for ads to reduce the effects of fraud.

FIG. 3 is a flow diagram illustrating the logical steps of a mode of dual pricing when a buyer submits a per selection bid.

FIGS. 4A-4D represent exemplary results of an auction conducted according to the flow diagram of FIG. 3 using dual pricing.

FIGS. 5A-5C represent exemplary results of a plurality of auctions conducted according to the flow diagram of FIG. 3 during which a buyer fraudulently selects its own ads.

FIGS. 6A-6B are flow diagrams illustrating the logical steps of a mode of dual pricing to reduce effects of a bidder's own fraudulent behavior.

FIG. 7 is a block diagram of a computing-system environment suitable for administering dual pricing.

### DETAILED DESCRIPTION

Pricing to Reduce Effects of Fraudulent Manipulation of Advertisements

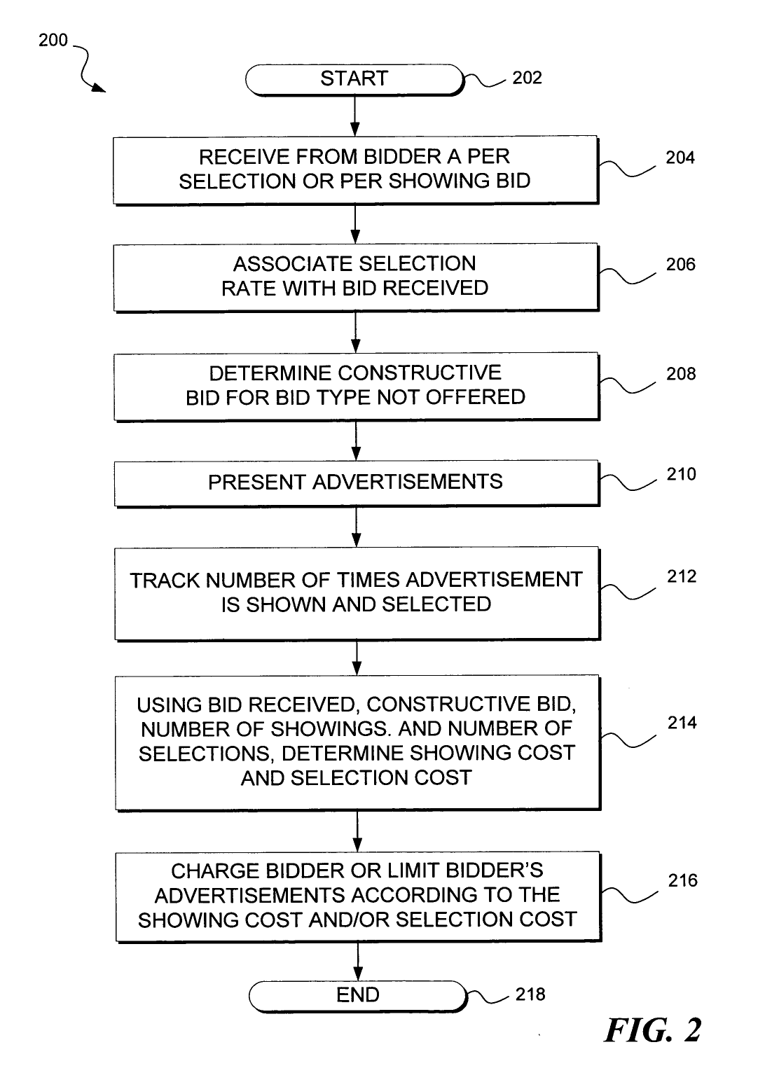

Flow diagram 200 of FIG. 2 shows a process for reducing effects of fraudulent activity targeted at selectable advertisements presented over a network. As previously described, for example, a bidder may offer a per selection bid for advertising opportunities and specify an auction budget or limit the bidder is willing to spend. An unscrupulous competitor may repeatedly invoke the bidder's ads and select them to quickly exhaust the bidder's auction budget.

In the foregoing example, the competitor only needed to invoke a showing of the ad 50 times and click on it each time to exhaust the bidder's budget. Similarly, although more tedious, if the bidder offered a per showing bid, the competitor also could attempt to exhaust the bidder's budget by repeatedly executing a search causing the bidder's ad to be shown, without having to select the ad to deplete the bidder's auction budget.

However, using dual pricing to track costs resulting from the numbers of times an ad both is selected and is shown, an unscrupulous competitor would both have to invoke a large number of showings of the bidder's ad and select the ad numerous times to exhaust the bidder's auction budget. At the very least, the competitor's actions to both invoke a showing of the ad and select the ad many times would yield a large body of behavioral data for machine learning systems to learn to identify instances of fraudulent behavior.

Flow diagram 200 of FIG. 2 illustrates logical steps of a mode of dual pricing to reduce effects of fraudulent behavior. Flow diagram 200 starts at block 202. At block 204, one of a per selection bid and a per showing bid is received from a bidder. The bidder also may provide an auction budget or limit capping what it is willing to spend on the auction. At block 206, a selection rate is associated with the bid received from the bidder. The selection rate indicates likelihood that an ad will be selected. One example of a selection rate is a “click-through rate” (CTR), which signifies represents how many times the ad presented by the bidder will be selected, relative to how many times the ad is shown, as described in Eq. 1:

$$CTR = \frac{\begin{matrix}\# of times advertisement \\ selected during an interval\end{matrix}}{\begin{matrix}\# of times advertisement \\ shown during the interval\end{matrix}} \qquad ( 1 )$$

The CTR may be based on historical data for the bidder's ads. For example, if it is known how many times an ad presented by the bidder was selected relative to how many times the ad was shown during a previous auction period, the CTR is obtainable by simple division. Alternatively, the CTR may be estimated for a particular bidder by extrapolating from advertisers in similar industries having known CTRs. Alternatively, a default CTR value may be used.

At block 208, an equivalent, constructive bid is determined to represent the other type of bid the bidder could have presented. In other words, if the bidder offers a per selection bid, a constructive per showing bid is determined. As previously described, the CTR provides a ratio of how many times an ad is selected per the number of times shown. Thus, if a bidder presents a per selection bid, b_{selection}, an equivalent per showing bid, b_{showing}, can be calculated using Eq. 2:
b_{showing}=b_{selection}×CTR (2)
Similarly, if a bidder offers a particular bid per showing, b_{showing}, an equivalent bid per selection is derivable from Eq. 3:

$${b}_{selection} = \frac{{b}_{showing}}{CTR} \qquad ( 3 )$$

Thus, for example, if a bidder were to offer a per selection bid of $1.00, and the CTR associated with the bidder is 1% (0.01), an equivalent, constructive per showing bid is obtainable by inserting these values into Eq. 2:
b_{showing}=b_{selection}×CTR=$1.00×0.01=$0.01
Similarly, if a bidder were to offer a per showing bid of $0.01, and the CTR associated with the bidder once again is 1% (0.01), an equivalent, constructive per selection bid is obtainable by inserting these values into Eq. 3:

$${b}_{selection} = \frac{{b}_{showing}}{CTR} = \frac{\$0 .01}{0.01} = \$1 .00$$

Using a constructive, equivalent bid for the bid not offered by the buyer is used to reduce the effect of fraudulent behavior, as is further described below.

At block 210, ads are presented. Ads are selected, auctioned, and/or sequenced according to any one of a number known processes. The bidder may present a single ad to be presented repeatedly, or a pool of ads that will be rotated sequentially or drawn according to another method.

As the ads are presented, at block 212, a number of times the ad is selected and a number of times the ad is shown are tracked. At block 214, a showing cost and a selection cost are determined. The selection cost is determined by multiplying the number of times the ad was selected by the per selection bid. The per selection bid may include an actual per selection bid or a constructive per selection bid derived from the per showing bid and the CTR. The showing cost is determined by multiplying the number of times the ad was shown by the per showing bid. The per showing bid may include an actual per showing bid or a constructive per showing bid derived from the per selection bid and the CTR.

At block 218, the bidder will be charged, or the bidder's ads will be limited based on one or both of the computed costs. For example, the bidder's auction budget may be considered exhausted when both the selection cost and the showing cost reach the limit. Thus, if an unscrupulous competitor attempted to exhaust the bidder's auction budget by repeatedly selecting the bidder's ads, the competitor would fail unless the competitor also managed to invoke enough showings of the bidder's ads to exhaust the bidder's auction budget on a per showing basis.

For another example, at the end of the auction period, the bidder may be charged the lesser of the selection cost and the showing cost. Thus, even if the unscrupulous competitor was unable to or did not intend to exhaust the bidder's budget, but hoped to increase the bidder's costs, the competitor would have to both invoke many showings of the ad and select many ads to increase both costs sufficiently to disadvantage the bidder. Flow diagram 200 ends at block 218.

Example of Dual Pricing Helping a Bidder with a Small Budget

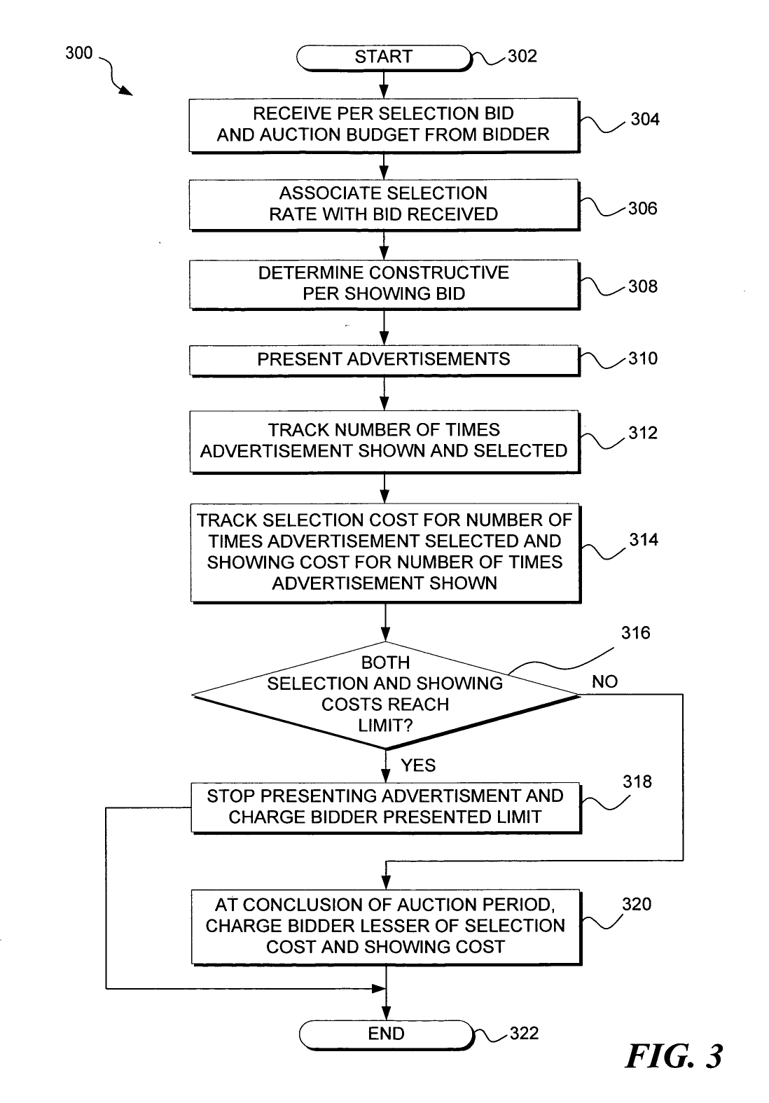

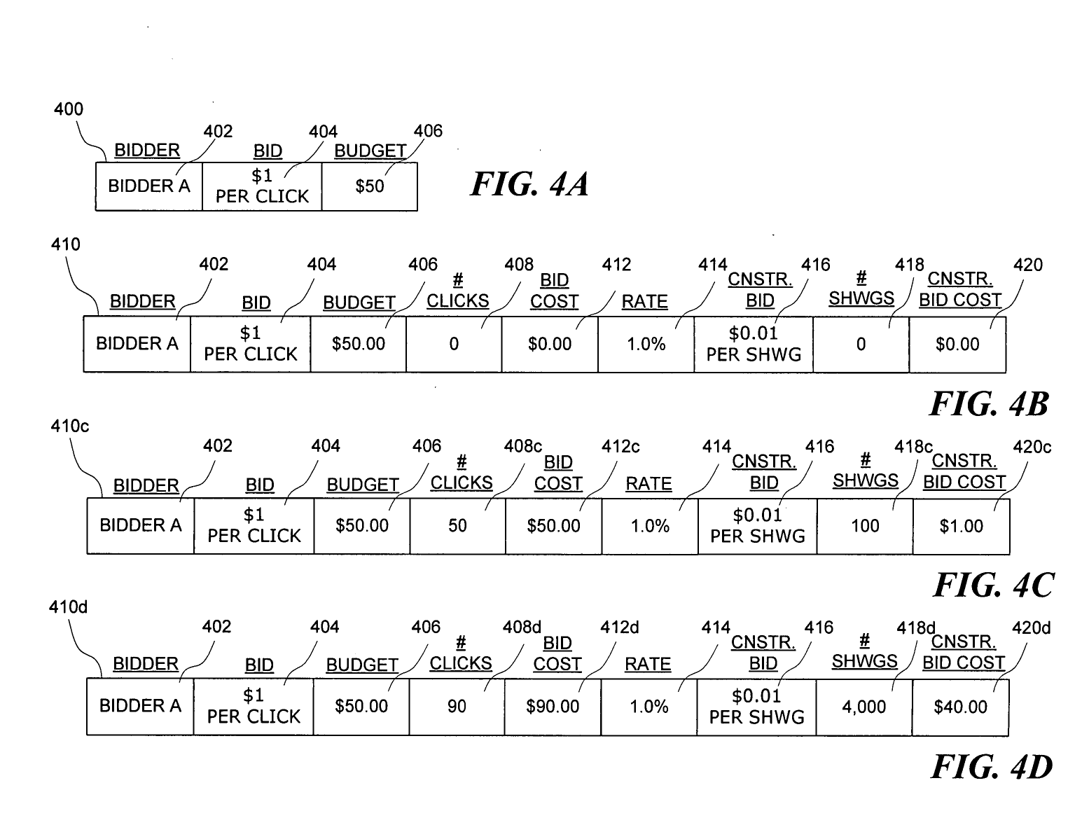

Previously, in the example of “DISCOUNT CAMERA” attempting to undermine “BOB'S CAMERA,” it was described that BOB'S CAMERA was described as a small business with a small advertising budget. Further, BOB'S CAMERA determined it would be most successful if it purchased advertising opportunities on a per selection basis. Unfortunately, BOB'S CAMERA's strategy allowed DISCOUNT CAMERA to exhaust BOB'S CAMERA's auction budget. Flow diagram 300 of FIG. 3, along with the examples of FIGS. 4A-4D, illustrates how dual pricing thwarts efforts of an unscrupulous competitor.

Flow diagram 300 begins at block 302. At block 304, a per selection bid and an auction budget are received from a bidder. At block 306, a rate, such as a CTR, is associated with the bid. At block 308, a constructive per showing bid is determined using the per selection bid and the rate. At block 310, the ad is shown to users over a network. At block 312, a number of times the ad is shown and the number of times the ad is selected are tracked.

At block 314, a selection cost, derived by combining the number of times the ad is selected with the per selection bid, and a showing cost, derived by combining the number of times the ad is shown with the constructive per showing bid, are tracked. At decision block 316, it is determined if both the selection cost and the showing cost have reached the auction budget. If both costs have reached the auction budget, at block 318, presentation of the ad will stop, and the bidder is charged the full auction budget. On the other hand, if at decision block 316 it is determined that the selection costs and the showing cost have not both reached the auction budget, at block 320, at the conclusion of the auction period, a lesser of the selection cost and the showing cost is charged to the bidder. Flow diagram 300 ends at block 322.

A competitor selecting the bidder's ad enough times for the selection cost to reach the auction budget will not deplete the bidder's auction budget. The budget will not be considered depleted until both the number of selections combined with the per selection bid and the number of showings combined with the per showing cost reach the budget. Thus, although the bidder's ad may receive more selections than for which the bidder paid, the bidder's ad is shown as many times as the selection rate combined with the constructive per showing cost would indicate the ad should be shown, regardless of the fraudulent behavior.

The provider of the advertising opportunities bears the risk of the bidder receiving more selections or clicks than for which the bidder budgeted or will pay. However, because a competitor's fraudulent behavior is not rewarded, similar fraudulent behavior will be deterred. Further, because bidders will receive a fair number of advertising opportunities even when someone attempts to defraud them, bidders should be satisfied. Thus, bidders can be expected to continue to reasonably bid for advertising opportunities, thereby helping to maintain market price of the advertising opportunities.

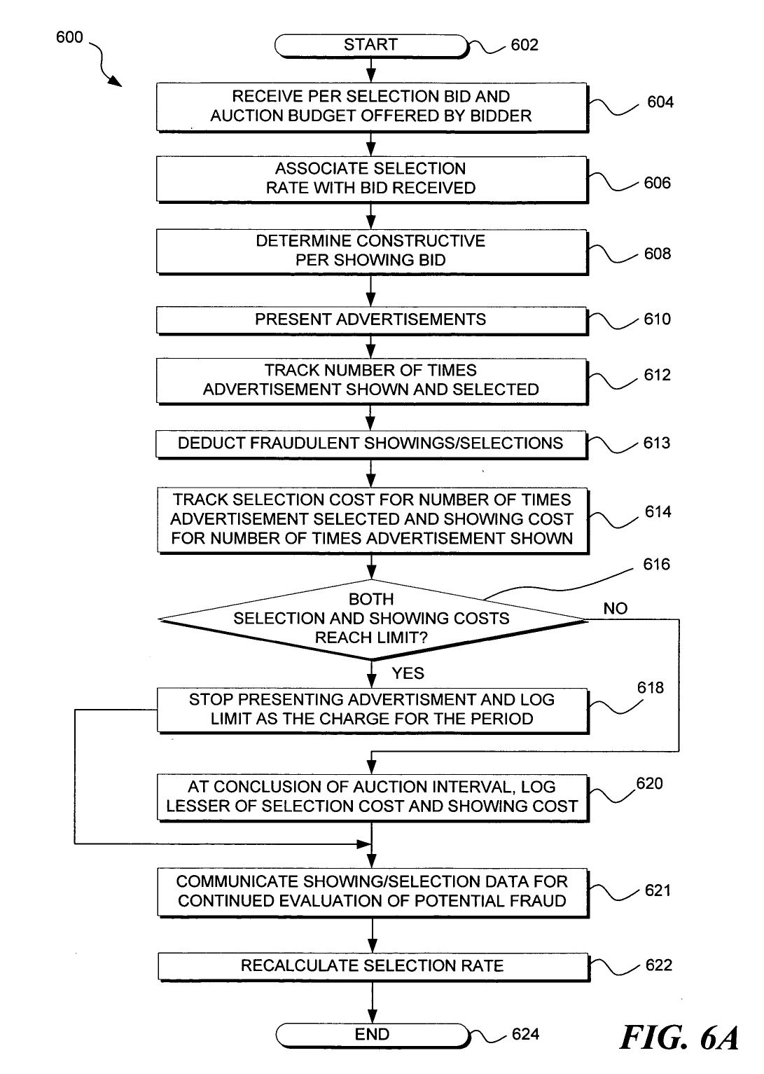

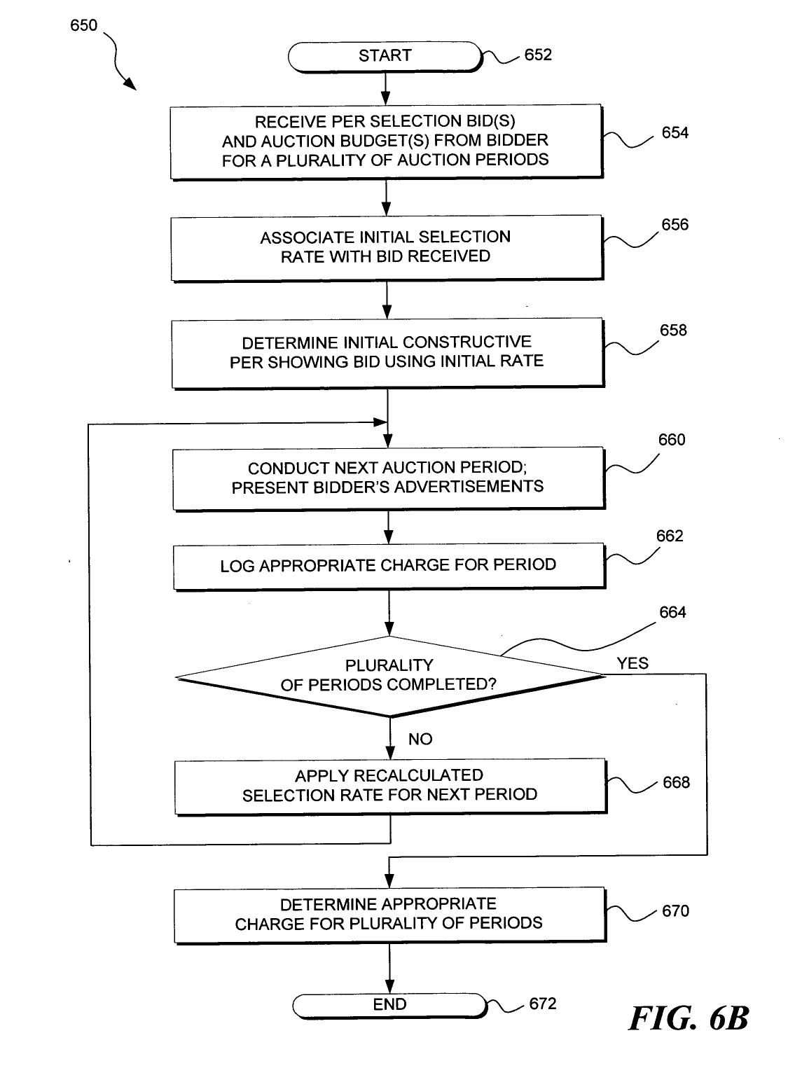

In addition, even when fraud is attempted, dual pricing will cause the ad to be presented a sufficient number of times to yield a large data set concerning the showing and the selection of the bidder's ads. The large data set will help machine learning systems or other fraud detection systems to reliably identify potential fraud in the invocation and/or selection of ads. In one embodiment, therefore, the data set resulting from dual pricing is shared with a fraud detection system. In a further embodiment, the fraud detection system is employed in a dual pricing system to detect fraudulent selections or showings, and deduct resulting charges from the bidder's account. Interaction with a fraud detection system is further described below in connection with FIG. 6A.

FIGS. 4A-4D represent an example of dual pricing according to flow diagram 300 of FIG. 3 reduce effects of fraud. FIG. 4A shows a bid 400 presented by BIDDER A 402. Although modes of dual pricing may be applied to any number of bidders, FIGS. 4A-4D illustrate how dual pricing protects a single bidder.

Bid 400 specifies the actual per selection bid 404 presented by BIDDER A 402, a per selection of $1. Bid 400 also specifies a limit or auction budget 406 BIDDER A 402 is willing to spend on the auction. In this case, BIDDER A 402 has specified a limit 406 of $50.

Consistent with the logical steps described in flow diagram 300 (FIG. 3), bid 400 (FIG. 4A) is expanded to yield a dual price record 410 of FIG. 4B. Dual price record 410 includes data to be associated with bid 400 prior when the auction commences. In particular, in addition to the per selection bid 404 and the auction budget 406, dual price record 410 also tracks a number of times the ad is selected 408, and monitors a bid cost 412 resulting from per selection bid 404. Cost 412 represents a product of the number of times the ad is selected 408 by the bid 404.

In addition, a rate 414 is associated with dual price record 410. Rate 414, for example, represents an historical, estimated, or default click-through rate to be used for the duration of the first auction period or interval. Rate 414 is 1.0%, which signifies an expectation that the ad will be selected once for each 100 times the ad is shown. Using bid 404 and rate 414, a constructive bid 416 is determined. Because BIDDER A 402 offered a per selection bid, constructive bid 416 is a per showing bid. If BIDDER A 402 had offered a per showing bid, the constructive bid would be a constructive per selection bid derived from the per showing bid and the rate. As shown in FIG. 4B, and according to Eq. 3, a constructive per showing bid is determinable by multiplying the per selection bid by the rate, or in this case:
constructive b_{showing}=b_{selection}×CTR=$1.00×0.01=$0.01
Thus, constructive bid 416 is a per showing bid of $0.01. Dual price record also monitors a number of times the ad is shown 418 and a total constructive cost 420.

FIG. 4C represents a dual-bid record 410c representing a point in the auction after a competitor has attempted to exhaust the auction budget of BIDDER A 402. Despite the number of showings 418c totaling only 100, the number of selections 408c totals 50. Despite an expected selection rate 414 of 1%, the ad has been selected 50% of the time, suggesting fraudulent activity.

In a conventional auction, after the number of clicks 408c reached 50 at a bid 404 of $1 per selection, the $50 auction budget 406 of BIDDER A 402 would have been depleted. However, because the auction budget is not considered depleted until reached by both the bid cost 412c and the constructive bid cost 420c, ads of BIDDER A 402 will continue to be shown. After only 100 showings 418c, the constructive bid cost 420c has only reached $1.00. Thus, based on rate 414, BIDDER A 402 still may earn up to 4,900 additional showings of the ad before its limit 406 is reached, or will pay only the showing cost 420c regardless of the number of selections 408c or the total selection cost 412c.

FIG. 4D shows a dual-bid record 410d for BIDDER A 402 from a later point in the auction. Apparently, the competitor has been discouraged from trying to exhaust the budget 404 of BIDDER A. After a number of showings 418d reaches 4,000, the number of selections 408d totals 90. Again, for 90 selections, the bid cost 412d reaches $90 and, thus, far exceeds budget 406. Nonetheless, with the number of showings 418d reaching 4,000 and the rate 414 at 1.0%, the constructive showing cost 420d totals $40, still below limit 406. Thus, BIDDER A's ads 402 continue to be shown, despite the competitor's fraudulent actions.

Deterring a Bidder's Own Fraud Resulting in Dual Pricing

Although dual pricing protects a bidder from unethical actions by competitors, dual pricing may encourage a bidder to fraudulently select the bidder's own ads. Without dual pricing, a bidder's selection of its own ads would only deplete a portion of the bidder's own auction limit. With dual pricing, however, both competitors and the bidder can select the bidder's ads without exhausting the bidder's auction budget. Moreover, there are benefits to selecting one's own ads, and bidders may fraudulently select their own ads. There are at least three reasons a bidder may select its own ads. All three reasons concern the advantages of increasing the bidder's selection rate or CTR.

The first reason a bidder would want to boost its own selection rate is to improve its position to win advertising opportunities. Some providers of advertising opportunities award the opportunities according to an effective bid based on the CTR. While a bidder may offer a relatively high bid per selection, if the ad is unlikely to be selected, the provider is unlikely to earn advertising revenue. A typical formula for an effective bid is similar to the bid per showing formula of Eq. 2, and weights per selection bids by CTR as shown in Eq. 4:
Effective bid=b_{selection}×CTR (4)
Thus, by doubling one's own CTR, one can double its effective bid, and be more likely to secure advertising opportunities.

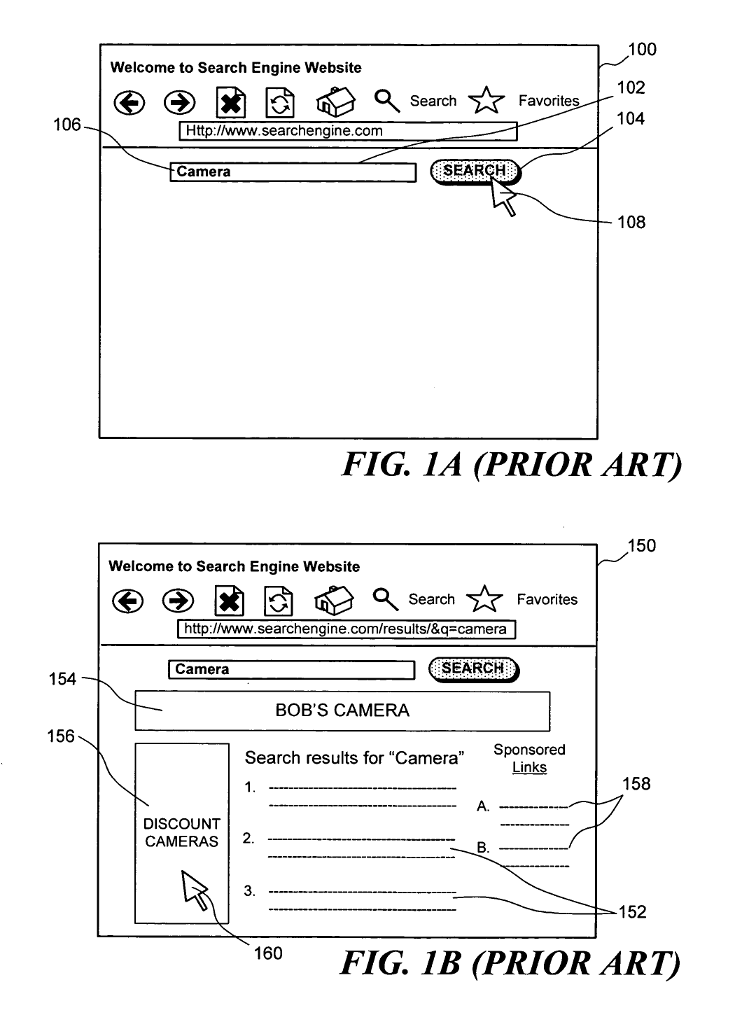

The second reason a bidder would want to increase its CTR is to improve the rankings of its ads within a page. In the example of FIG. 1B, on results page 150 there were two sponsored links 158, A and B, with A listed before B. It is widely understood that the higher a link is ranked, the more likely it will be selected. For example, sponsored link A might be twice as likely or more to be selected than sponsored link B.

Between the bidders who secured sponsored links 158, sponsored link A typically is awarded to the bidder with the higher CTR. The provider of the advertising opportunities desires to maximize revenue. The likelihood of high revenues increase if ads more likely to be selected are presented where any ad will have the best opportunity to be selected. Thus, a bidder with a higher CTR is more likely to earn the coveted, high-ranking spots.

The third reason a bidder would want to increase its CTR is an effect of dual pricing itself. As previously explained in connection with Eq. 3, the higher a bidder's CTR is, the lower the bidder's constructive per selection bid will be. Thus, for a given bid per showing bid, a constructive per selection bid varies inversely with CTR:

$${b}_{selection} = \frac{{b}_{showing}}{CTR} \qquad ( 3 )$$

Thus, if a bidder offering a per showing bid has a high CTR, the price the bidder will be charged when its ad is selected is less than a bidder with a lower CTR.

However, despite the advantages resulting from selecting one's own ad to increase CTR, and dual pricing facilitates the selection of one's own ads, dual pricing also is adaptable to deter selection of one's own ads.

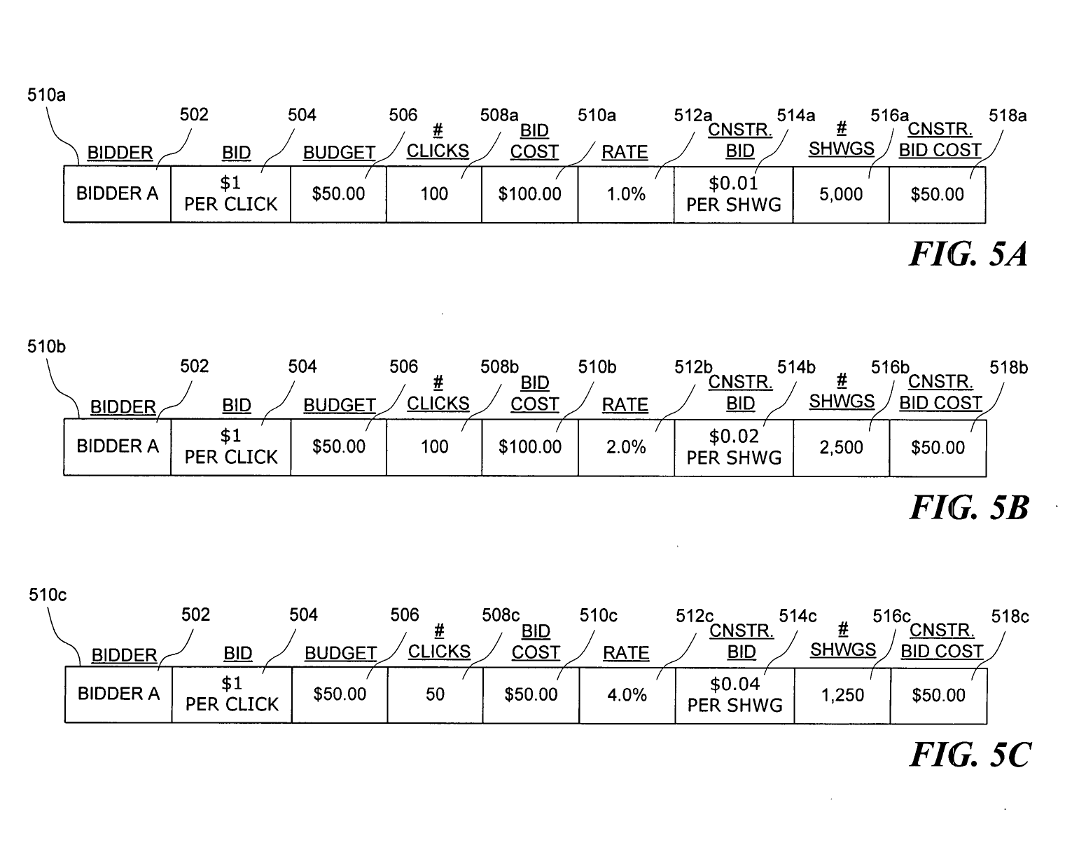

FIGS. 5A-5C illustrate examples of changing selection rates and its effect on per showing costs as a result of a bidder's own fraudulent behavior. In FIG. 5A, dual pricing record 510a shows that BIDDER A 502 offers a per selection bid 504 of $1. An initial rate 512a of 1% is associated with BIDDER A 502. From the per selection bid 504 and the rate 512a, an equivalent, constructive per showing bid 514a is determined to be $0.01.

The number of selections counted 508a includes 100 selections for a number of showings 516a totaling 5,000. With a 1% selection rate, 50 selections would be expected. However, the number of selections 508a is double that total. It is assumed that the extra 50 selections are the result of BIDDER A 502 selecting its own ads. The resulting bid cost 510a is $100, double the auction budget 506 of $50. However, because of dual pricing, BIDDER A 502 earns 5,000 showings before the constructive, per showing cost 518a also reaches limit 506. Thus, dual pricing protects BIDDER A 502 even from his own “click fraud.”

FIG. 5B shows a dual pricing record adjusted after the auction yielding the results of FIG. 5A. For BIDDER A 502, the per selection bid 504 and the limit 506 remain the same. Again, the number of selections 508b totals 100, including 50 earnest selections and 50 selections by BIDDER A 502. At a bid 504 of $1 per selection, the per selection cost 510b again reaches $100, twice the auction budget 506 of $50. However, as a result of the number of selections 508a (FIG. 5A) in the last auction period being double what was expected for the number of showings 516a, the selection rage 512b doubles to 2.0%. Using Eq. 2 to derive the equivalent, constructive per showing bid, the new constructive bid 514b doubles to $0.02 per showing.

The number of selections 508b totaling 100 at a bid 504 of $1 per selection again is double the limit 506 of $50. Despite far exceeding the limit 506 of $50 on a per selection basis, using dual pricing, ads continue to be presented for BIDDER A 502. However, in contrast to the example of FIG. 5A, at the updated constructive bid 514b, the constructive, per showing cost 518b reaches the limit 506 at a total number of showings 516b of 2,500, half of showings 518a (FIG. 5A) BIDDER A 502 received in the previous auction.

Dual pricing record 510c of FIG. 5C represents an auction where it is assumed that BIDDER A 502 cuts back on the number of selections of its own ads, cutting back from 50 selections to 25. BIDDER A 502 presents the same bid 504 of $1 per selection, and the same auction budget 504 of $50. By contrast, other quantities in dual pricing record 510c have changed. By receiving 100 selections 508b (FIG. 5B) for 2,500 showings 516b in the last auction period, a revised selection rate 512c increases to 4%, and the resulting equivalent, constructive bid 514c increases to $0.04 per showing.

The selection cost 510c reaches the limit 506 of $50 after only 50 selections, only 25 of which were not initiated by BIDDER A 502. As a result of the increased constructive bid 512c, the constructive, per showing cost 518c reaches the limit 506 after only 1,250 showings 516c. Thus, eventually, selecting one's own ads increases the constructive, per showing rate to the point that an ad will be shown far fewer times before both the selection cost and the showing cost reach the auction budget. Thus, by adjusting the selection rate between auction periods, and committing bidders for a number of auction periods, bidders will be deterred from selecting their own ads.

Flow diagram 600 of FIG. 6A illustrates logical steps for employing dual pricing in a manner that reduces the effects of fraudulent selection of ads, whether the fraud is perpetrated by the bidder or another party. Flow diagram 600 begins at block 602. At block 604, a per selection bid and an auction limit are received from the bidder. Flow diagram 600 illustrates an example of dual pricing based on receiving a per selection bid. However, as previously described, dual pricing also is operable to reduce the effects of fraudulent behavior when a bidder offers a per showing bid.

At block 606, a selection rate or CTR is associated with the bid received. At block 608, using the per selection bid received at block 604 and the rate associated with the bid at block 606, a constructive per showing bid is calculated. At block 610, ads are then presented. At block 612, the number of times the bidder's ad is shown and the number of times the bidder's ad is selected are tracked.

As previously described in connection with FIG. 3, dual pricing helps to provide a larger data set for machine learning systems or other fraud detection systems to identify fraudulent invocation or selection of ads. At block 613, showings or selections of ads identified by the fraud detection system are deducted from the number of showings and selections, respectively, tracked at block 612. If the fraud detection system identifies that the fraudulent actions have been perpetrated by the bidder, the data may be adjusted accordingly. For example, fraudulent selections made by the bidder may be included in the number of selections for calculating the selection cost, but may later be deducted from the number of selections to prevent the bidder from manipulating the CTR as previously described.

At block 614, selection and showing costs are calculated and tracked using the number of showings and selections, the per selection bid, and the constructive per showing bid. At decision block 616, it is determined if both the selection and showing costs have reached the auction budget. If so, at block 618, the ad will no longer be presented, and the limit is logged as the appropriate charge for the period. On the other hand, if both the selection and showing costs have reached the limit, at block 620, at the conclusion of the auction period, the lesser of the selection and showing costs is logged as the charge for the period.

At block 621, showing and selection data are communicated to a fraud detection system to help the system refine its ability to detect fraudulent activity. At block 622, the selection rate is recalculated to reflect the number of selections and number of showings for the bidder's ad so that a current rate is applied during subsequent auction periods. Flow diagram 600 ends at block 624.

Flow diagram 650 of FIG. 6B illustrates logical steps for charging a bidder for a plurality of auction periods to offset the effects of fraudulent activity by the bidder, as described in connection with FIGS. 5A-5C. Flow diagram 650 begins at block 652. At block 654, one or more per selection bids and one or more auction limits are received from a bidder for a plurality of auction periods. Again, embodiments of dual pricing are adaptable to receive a per showing bid instead of a per selection bid. At block 656, an initial rate is associated with the bid. The initial rate may be historical, estimated, or set by default. At block 658, an initial constructive per showing bid is derived from the per selection bid and the rate.

At block 660, the next auction period is conducted and the bidder's ads are presented as previously described in connection with FIG. 6A. At block 662, at the end of the auction period, the appropriate charge is logged for the period, as also is described in flow diagram 600. At decision block 664, it is determined if the plurality of periods has been completed. If not, at block 668, the recalculated rate determined at block 662 of flow diagram 600 is applied for the next auction period, and flow diagram 650 loops to block 660 for the next auction period.

On the other hand, if it is determined at decision block 664 that the plurality of auction periods has been completed, at block 670, the appropriate price to charge the bidder is determined for the plurality of auction periods. The appropriate price is determinable in a number of ways. For one, as indicated in the example of FIGS. 5A-5C, the bidder may be required to present bids for a plurality of periods to prevent the bidder from strategically bidding for individual periods based on the bidder's ability to manipulate its own CTR.

Alternatively, the price could be determined by averaging the CTR over the plurality of periods. For example, in a period where both the selection cost and the showing cost do not reach the stated limit, the bidder would be charged the lesser of the two prices, and less than the stated limit. However, if the selection or click-through rate increased significantly over the plurality of periods, which may suggest the bidder manipulated its CTR, an averaged rate may be applied in retroactively calculating the showing costs for a period to increase the price to the bidder for that period. Further alternatively, a highest click-through rate may be used in retroactively calculating the constructive per showing bid to increase the price for those periods.

Computing System for Implementing Exemplary Embodiments

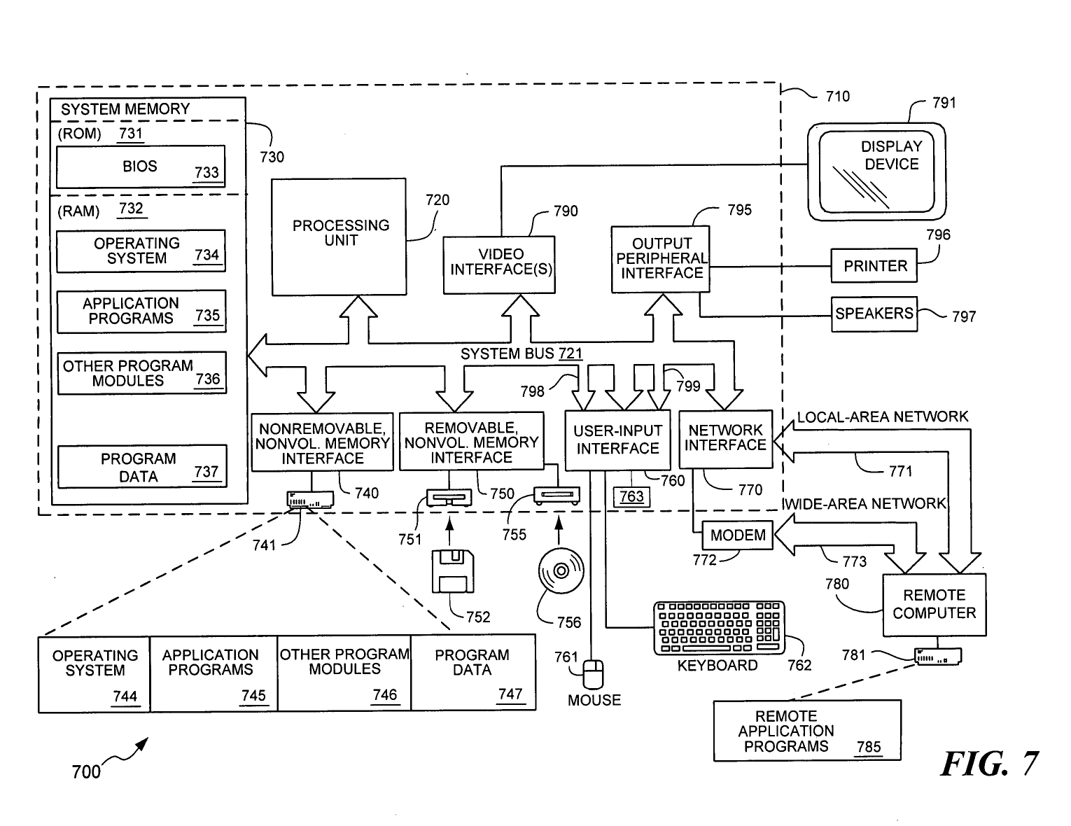

FIG. 7 illustrates an exemplary computing system 700 for implementing embodiments of dual pricing. The computing system 700 is only one example of a suitable operating environment and is not intended to suggest any limitation as to the scope of use or functionality of exemplary embodiments of dual pricing previously described or other embodiments. Neither should the computing system 700 be interpreted as having any dependency or requirement relating to any one or combination of components illustrated in the exemplary computing system 700.

Dual pricing may be described in the general context of computer-executable instructions, such as program modules, being executed on computing system 700. Generally, program modules include routines, programs, objects, components, data structures, etc., that perform particular tasks or implement particular abstract data types. Moreover, those skilled in the art will appreciate that dual pricing may be practiced with a variety of computer-system configurations, including hand-held devices, multiprocessor systems, microprocessor-based or programmable-consumer electronics, minicomputers, mainframe computers, and the like. Dual pricing may also be practiced in distributed-computing environments where tasks are performed by remote-processing devices that are linked through a communications network. In a distributed-computing environment, program modules may be located in both local and remote computer-storage media including memory-storage devices.

With reference to FIG. 7, an exemplary computing system 700 for implementing dual pricing includes a computer 710 including a processing unit 720, a system memory 730, and a system bus 721 that couples various system components including the system memory 730 to the processing unit 720.

Computer 710 typically includes a variety of computer-readable media. By way of example, and not limitation, computer-readable media may comprise computer-storage media and communication media. Examples of computer-storage media include, but are not limited to, Random Access Memory (RAM); Read Only Memory (ROM); Electronically Erasable Programmable Read Only Memory (EEPROM); flash memory or other memory technology; CD ROM, digital versatile discs (DVD) or other optical or holographic disc storage; magnetic cassettes, magnetic tape, magnetic disk storage or other magnetic storage devices; or any other medium that can be used to store desired information and be accessed by computer 710. The system memory 730 includes computer-storage media in the form of volatile and/or nonvolatile memory such as ROM 731 and RAM 732. A Basic Input/Output System 733 (BIOS), containing the basic routines that help to transfer information between elements within computer 810 (such as during start-up) is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/nonremovable, volatile/nonvolatile computer-storage media. By way of example only, FIG. 7 illustrates a hard disk drive 741 that reads from or writes to nonremovable, nonvolatile magnetic media, a magnetic disk drive 751 that reads from or writes to a removable, nonvolatile magnetic disk 752, and an optical-disc drive 755 that reads from or writes to a removable, nonvolatile optical disc 756 such as a CD-ROM or other optical media. Other removable/nonremovable, volatile/nonvolatile computer-storage media that can be used in the exemplary operating environment include, but are not limited to, magnetic tape cassettes, flash memory units, digital versatile discs, digital video tape, solid state RAM, solid state ROM, and the like. The hard disk drive 741 is typically connected to the system bus 721 through a nonremovable memory interface such as interface 740. Magnetic disk drive 751 and optical dick drive 755 are typically connected to the system bus 721 by a removable memory interface, such as interface 750.

The drives and their associated computer-storage media discussed above and illustrated in FIG. 7 provide storage of computer-readable instructions, data structures, program modules and other data for computer 710. For example, hard disk drive 741 is illustrated as storing operating system 744, application programs 745, other program modules 746, and program data 747. Note that these components can either be the same as or different from operating system 734, application programs 735, other program modules 736, and program data 737. Typically, the operating system, application programs, and the like that are stored in RAM are portions of the corresponding systems, programs, or data read from hard disk drive 741, the portions varying in size and scope depending on the functions desired. Operating system 744, application programs 745, other program modules 746, and program data 747 are given different numbers here to illustrate that, at a minimum, they can be different copies. A user may enter commands and information into the computer 710 through input devices such as a keyboard 762; pointing device 761, commonly referred to as a mouse, trackball or touch pad; a wireless-input-reception component 763; or a wireless source such as a remote control. Other input devices (not shown) may include a microphone, joystick, game pad, satellite dish, scanner, or the like. These and other input devices are often connected to the processing unit 720 through a user-input interface 760 that is coupled to the system bus 721 but may be connected by other interface and bus structures, such as a parallel port, game port, IEEE 1394 port, or a universal serial bus (USB) 798, or infrared (IR) bus 799. As previously mentioned, input/output functions can be facilitated in a distributed manner via a communications network.

A display device 791 is also connected to the system bus 721 via an interface, such as a video interface 790. Display device 791 can be any device to display the output of computer 710 not limited to a monitor, an LCD screen, a TFT screen, a flat-panel display, a conventional television, or screen projector. In addition to the display device 791, computers may also include other peripheral output devices such as speakers 797 and printer 796, which may be connected through an output peripheral interface 795.

The computer 710 will operate in a networked environment using logical connections to one or more remote computers, such as a remote computer 780. The remote computer 780 may be a personal computer, and typically includes many or all of the elements described above relative to the computer 710, although only a memory storage device 781 has been illustrated in FIG. 7. The logical connections depicted in FIG. 7 include a local-area network (LAN) 771 and a wide-area network (WAN) 773 but may also include other networks, such as connections to a metropolitan-area network (MAN), intranet, or the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the network interface 770, or other appropriate mechanism. Modem 772 could be a cable modem, DSL modem, or other broadband device. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary, and other means of establishing a communications link between the computers may be used.

Although many other internal components of the computer 710 are not shown, those of ordinary skill in the art will appreciate that such components and the interconnections are well-known. For example, including various expansion cards such as television-tuner cards and network-interface cards within a computer 710 is conventional. Accordingly, additional details concerning the internal construction of the computer 710 need not be disclosed in describing exemplary embodiments of the auction process.

When the computer 710 is turned on or reset, the BIOS 733, which is stored in ROM 731, instructs the processing unit 720 to load the operating system, or necessary portion thereof, from the hard disk drive 741 into the RAM 732. Once the copied portion of the operating system, designated as operating system 744, is loaded into RAM 732, the processing unit 720 executes the operating system code and causes the visual elements associated with the user interface of the operating system 734 to be displayed on the display device 791. Typically, when an application program 745 is opened by a user, the program code and relevant data are read from the hard disk drive 741 and the necessary portions are copied into RAM 732, the copied portion represented herein by reference numeral 735.

### CONCLUSION

Although exemplary embodiments have been described in language specific to structural features and/or methodological acts, it is to be understood that the appended claims are not necessarily limited to the specific features or acts previously described. Rather, the specific features and acts are disclosed as exemplary embodiments.

1. A method for determining a price for presenting an advertisement that is selectable upon being shown, the method comprising:
identifying a rate representing how many times the advertisement will be selected relative to how many times the advertisement is shown;
associating with the advertisement a per selection price including one of:
a per selection bid offered; and
a constructive per selection price based on the rate and a per showing bid offered, when the per selection bid is not offered;
associating with the advertisement a per showing price including one of:
the per showing bid offered; and
a constructive per showing price based on the rate and the per selection bid offered when the per showing bid is not offered;
determining a showing cost combining a number of times the advertisement is shown with the per showing price;
determining a selection cost combining a number of times the advertisement is selected with the per selection price; and
setting the price to one of the selection cost and the showing cost.

2. The method of claim 1, wherein the price is set to a lesser of the selection cost and the showing cost.

3. The method of claim 1, wherein the advertisement is drawn from a plurality of advertisements provided by a bidder.

4. The method of claim 1, wherein the rate includes one of:
an historical rate representing how many times the advertisement previously was selected relative to how many times the advertisement previously was shown over an historical interval;
an estimated rate representing an estimate of how many times the advertisement will be selected relative to a unit number of showings; and
a default rate.

5. The method of claim 1, wherein the price is calculated over the course of a plurality of periods.

6. The method of claim 5, further comprising replacing the rate with a revised rate in at least a portion of the plurality of periods, the revised rate representing how many times the advertisement previously was selected relative to how many times the advertisement previously was shown over at least one previous period.

7. The method of claim 1, further comprising receiving a budget for presenting the advertisement, and determining the budget is depleted when one of:
both the selection cost and the showing cost reach the budget; and
one of the selection cost and the showing cost reaches the budget.

8. The method of claim 1, further comprising communicating information representing events causing the advertisement to be at least one of shown and selected for detection of potentially fraudulent events.

9. The method of claim 8, further comprising reducing a portion of at least one of the showing cost and the selection cost resulting from the potentially fraudulent events detected.

10. A computer-readable medium having computer-useable instructions embodied thereon for executing the method of claim 1.

11. A method for establishing a price charged to an advertiser to account for effects of fraudulent selection of an advertisement selectable upon being shown, the method comprising:
receiving from the advertiser a per selection bid;
identifying a rate representing how many times the advertisement will be selected relative to how many times the advertisement is shown;
determining a constructive per showing price by combining the rate with the per selection bid;
determining a showing cost based on a number of times the advertisement is shown with the constructive per showing price;
determining a selection cost based on a number of times the advertisement is selected with the per selection bid; and
establishing the price as a lower of the selection cost and the showing cost.

12. The method of claim 11, wherein the advertisement is drawn from a plurality of advertisements provided by the advertiser.

13. The method of claim 11, wherein the rate includes one of:
an historical rate representing how many times the advertisement previously was selected relative to how many times the advertisement previously was shown over an historical interval;
an estimated rate representing an estimate of how many times the advertisement will be selected relative to a unit number of showings;
a default rate; and
a revised rate usable in at least a portion of the plurality of predetermined intervals, the revised rate representing how many times the advertisement previously was selected relative to how many times the advertisement previously was shown over at least one previous period.

14. The method of claim 11, wherein the price is established over a plurality of periods.

15. The method of claim 11, further comprising receiving from the advertiser a budget the advertiser is willing to spend for presenting the advertisement, and determining the budget is depleted when the lower of the selection cost and the showing cost reaches the budget.

16. The method of claim 11, further comprising communicating information representing events causing the advertisement to be at least one of shown and selected for detection of potentially fraudulent events.

17. The method of claim 16, further comprising reducing a portion of at least one of the showing cost and the selection cost resulting from the potentially fraudulent events detected.

18. A computer-readable medium having computer-useable instructions embodied thereon for executing the method of claim 11.

19. A system of charging for presenting selectable advertisements presented over a network to offset manipulation of showing and selection of the advertisements to affect subsequent presentation of the advertisements, the system comprising one or more computers programmed to perform actions comprising:
identifying a rate representing how many times the advertisement will be selected relative to how many times the advertisement is shown;
associating with the advertisement a per selection price including one of:
a per selection bid offered; and
a constructive per selection price based on the rate and a per showing bid offered, when the per selection bid is not offered;
associating with the advertisement a per showing price including one of:
the per showing bid offered; and
a constructive per showing price based on the rate and the per selection bid offered when the per showing bid is not offered;
determining a showing cost combining a number of times the advertisement is shown with the per showing price;
determining a selection cost combining a number of times the advertisement is selected with the per selection price; and
pricing the presentation of the advertisements based on a lesser of the showing cost and the selection cost.

20. The system of claim 19, wherein the system is further programmed to perform actions including:
receiving a plurality of bids for each of a plurality of periods;
receiving a plurality of budgets limiting an amount to be spent for presenting advertisements during each of a plurality of periods; and
at least one of:
revising the rate and at least one of the constructive per selection price and the constructive per showing price based on the rate and a bid applicable to each of the portion of periods for at least a portion of the periods; and
adjusting the pricing for the presentation of the advertisements over the plurality of periods by retroactively adjusting the rate and at least one of the constructive per selection price and the constructive per showing price based on the rate applied to at least a portion of the periods.
